(19) United States
(12) Patent Application Publication
(10) Pub. No.: US 2026/0065588 A1
(43) Pub. Date: Mar. 5, 2026

(54) VR MEMORY BANK AND METHOD FOR THE SAME

(71) Applicants: Xerxes A. Mangapit, Yardley, PA (US); Andrew W. Kush, Yardley, PA (US)

(72) Inventors: Xerxes A. Mangapit, Yardley, PA (US); Andrew W. Kush, Yardley, PA (US)

(21) Appl. No.: 19/375,177

(22) Filed: Oct. 30, 2025

Related U.S. Application Data
(63) Continuation-in-part of application No. 18/238,690, filed on Aug. 28, 2023.
(60) Provisional application No. 63/451,691, filed on Mar. 13, 2023.

(51) Int. Cl. G06T 17/00; G06Q 30/0601; G06T 19/00

(52) U.S. Cl. CPC G06T 17/00; G06Q 30/0643; G06T 19/003

(57) ABSTRACT

A method of operating a virtual reality (VR) memory bank includes creating a 360° virtual location from a 360° photograph to be displayed on a virtual reality headset; automatically detecting one or more planar regions, within the 360° virtual location, associated with a visual media device within the physical location; instantiating and anchoring a corresponding video-texture surface to each planar region; automatically detecting one or more objects, within the 360° virtual location, associated with an audio media device within the physical location; instantiating and anchoring a corresponding positional-audio source to each object; including media assets within the 360° virtual location, wherein the media assets comprise at least one visual media asset and/or at least one audio media asset; displaying the at least one visual media asset on at least one video-texture surface; and playing the at least one audio media asset on at least one positional-audio source.

### STATEMENT OF RELATED APPLICATION(S)

This application is a continuation-in-part of U.S. patent application Ser. No. 18/238,690 filed on Aug. 28, 2023, which claims the benefit of U.S. Provisional Patent Application No. 63/451,691 filed on Mar. 13, 2023, the disclosure of which is hereby incorporated by reference herein in its entirety.

### TECHNICAL FIELD

The present invention relates to the field of memory storage and viewing device utilizing virtual reality (VR) technology.

### BACKGROUND

As individuals age, many senior citizens move into assisted living homes, often when medical or safety concerns preclude them from independent living. Often, there are no residents left in the senior citizen's former home, so the residency is often sold to help cover expenses. It is often a difficult emotional transition for these senior citizens to leave behind the familiarity and associated memories of their previous home, especially a family home that has been lived in for many years. As the sale of the former home is often to a non-family member, it may be difficult or impossible for the senior citizen to ever visit the residency again.

In other instances, individuals may not be leaving permanently, but rather for extended periods of time. For example, an individual leaving for college may not return to their childhood home for many months at a time. They may miss their bedroom or other living spaces.

When an individual leaves home, they may also be leaving behind pictures or other items which have been placed around creating memories. It may be difficult to take these items to one's new living location due to size, storage, or transportation restrictions. This means these items would have to be left behind.

In other instances, as an individual ages, they may miss out on being able to visit familiar spaces, or even exciting new ones. Older individuals may not be able to travel much or at all. Further, even if some individuals are able to travel, they may need to travel with medical personnel or equipment. This may lead them to not wishing to travel or visit places, new or old. These individuals will most likely begin to miss familiar places, which may lead to sadness. Currently, there is no way of sharing these places with individuals who have trouble traveling or do not wish to travel due to complications.

Therefore, a need exists for a system to ease the emotional stress associated with leaving a memory-filled living space.

### SUMMARY

A first aspect of the present invention includes a method of operating a virtual reality (VR) memory bank including creating a 360° virtual location to be displayed on a virtual reality headset, wherein the 360° virtual location is a replication of a physical location created from a 360° photograph; automatically detecting one or more planar regions, within the 360° virtual location, associated with a visual media device within the physical location; instantiating and anchoring a corresponding video-texture surface to each planar region of the one or more planar regions; automatically detecting one or more objects, within the 360° virtual location, associated with an audio media device within the physical location; instantiating and anchoring a corresponding positional-audio source to each object of the one or more objects; including media assets within the 360° virtual location, wherein the media assets comprise at least one visual media asset and/or at least one audio media asset; when the media assets comprise at least one visual media asset, displaying, at the selection of an end user, the at least one visual media asset on at least one video-texture surface; and when the media assets comprise at least one audio media asset, playing, at the selection of the end user, the at least one audio media asset on at least one positional-audio source.

Another aspect of the present invention includes the visual media device comprises a television or a picture frame.

Another aspect of the present invention includes the audio media device comprises a radio, a record player, a gramophone, a compact disc (CD) player, a cassette player, a stereo system, a speaker, or an mp3 player.

Another aspect of the present invention includes the 360° photograph is captured by a 360° camera.

Another aspect of the present invention includes selecting one or more additional elements within the 360° virtual location.

Another aspect of the present invention includes assigning an interactive action to each additional element of the one or more additional elements.

Another aspect of the present invention includes at least one additional element of the one or more additional elements include a food item and the interactive action includes ordering the food item.

Another aspect of the present invention includes the interactive action includes directing the user to an online retailer.

Another aspect of the present invention includes the 360° virtual location comprises at least two rooms, and each room of the at least two rooms is connected to at least one other room of the at least two rooms by an entryway.

Another aspect of the present invention includes the VR memory bank is configured to facilitate the user walking from one room of the at least two rooms to another room of the at least two rooms through the entryway within the 360° virtual location.

Another aspect of the present invention includes access to the 360° virtual location is restricted, and the VR memory bank further comprises a custodian, the custodian grants access to one or more additional users as a contributor or an end user.

Another aspect of the present invention includes the VR memory bank allows the custodian and the one or more additional users granted access as a contributor to add media assets.

Another aspect of the present invention includes the added media assets are configured to be selectively displayed by the video-texture surface and/or to be selectively played by the positional-audio source.

Another aspect of the present invention includes selecting one or more additional elements within the 360° virtual location; and assigning an interactive action to each additional element of the one or more additional elements, wherein the interactive action includes a request to a third-party service external to the VR memory bank, and the custodian approves or denies the request.

Another aspect of the present invention includes at least one media policy stored on a policy engine.

Another aspect of the present invention includes the at least one media policy prevents an audio media asset from being displayed on a video-texture surface and prevents a visual media asset from being played on the positional-audio source.

Another aspect of the present invention includes the at least one media policy prevents media assets from being displayed or played outside of predetermined time windows.

In another aspect, any one or more aspects or features described herein may be combined with any one or more other aspects or features for additional advantage.

Other aspects and embodiments will be apparent from the detailed description and accompanying drawings.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

FIG. 1A is a view of a room, from a first viewpoint, created for use on a virtual reality device of a VR memory bank according to a first embodiment of the present invention.

FIG. 1B is a view of the room of FIG. 1A, from a second viewpoint, created for use on the virtual reality device.

FIG. 1C is a view of the room of FIG. 1A, from a third viewpoint, created for use on the virtual reality device.

FIG. 2 is a view of a second room created for use on the virtual reality device of the VR memory bank of FIG. 1A.

FIG. 3 is a flow chart of creating a profile for the VR memory bank of FIG. 1A.

FIG. 4 is a flow chart of adding media assets to the VR memory bank of FIG. 1A.

FIG. 5 is a flow chart of adding a user to the system for the VR memory bank of FIG. 1A.

FIG. 6 is a flow chart of managing a virtual reality experience of the VR memory bank of FIG. 1A.

FIG. 7 is a flow chart of enhancing the virtual reality experience of the VR memory bank of FIG. 1A.

FIG. 8 is a flow chart for creating a custom room and granting access to the same within the VR memory bank of FIG. 1A.

FIG. 9 is a wiring diagram of an embodiment of a VR memory bank.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

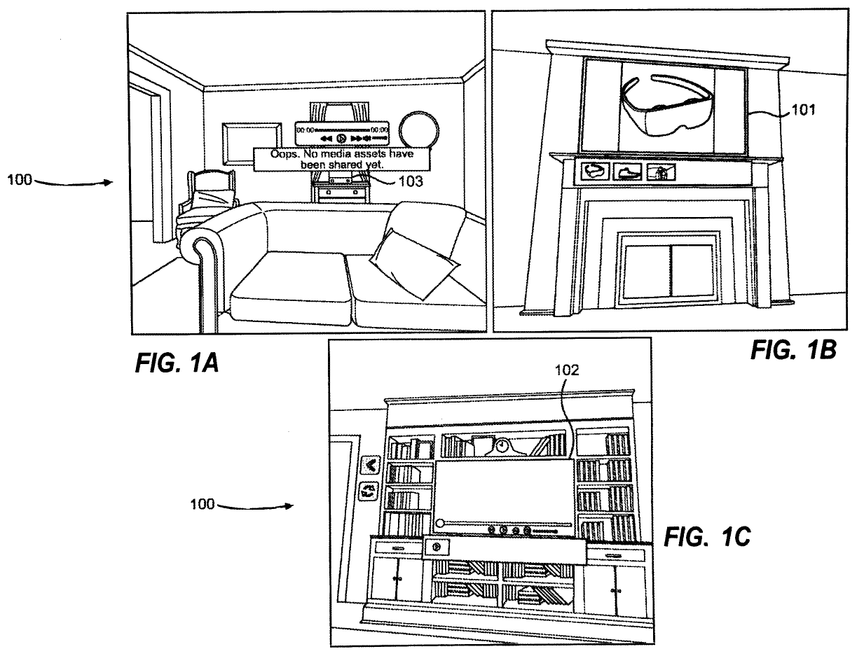

Referring now to FIGS. 1A-1C, there is shown a view of a 360° virtual location 100 created for use on a virtual reality (VR) device of the virtual reality (VR) memory bank. In an exemplary embodiment, the 360° virtual location 100 is a room 100 of a house or other building. In an exemplary embodiment, the room 100 is a custom created virtual space that resembles a room or other favorite space of a user. In an exemplary embodiment, the room 100 is configured as a living room, kitchen, dining room, den, bedroom, and/or any other room from a former residence of the user. In another embodiment, the room 100 is configured to be a park, a landmark, and/or any other suitable space special to the user. In an exemplary embodiment, the room 100 is not based on a real place from the life of the user, but instead is configured as a custom-made space designed for the display and/or listening of media assets (as described in detail below).

In an exemplary embodiment, the room 100 is configured to be a replication of a physical location. The replication may be generated based on a photograph of the physical location taken by a 360° camera. In an exemplary embodiment, the 360° camera may be configured as an omnidirectional camera that utilizes two or more wide angle lenses in a single device. In an alternative embodiment, the 360° camera may be a camera that rotates to take a series of pictures that are stitched together. In an exemplary embodiment, the room 100 may be configured as the replication of the physical location with additional elements added thereto. For example, the room 100 may have additional picture frames added to the walls, on a side table, on a nightstand, etc. to allow for additional media assets to be displayed (as discussed below).

In an exemplary embodiment, the 360° virtual location 100 may be configured as one room, two rooms, or n rooms of a physical location. For example, if the 360° virtual location 100 is a replication of a house of the user, the 360° virtual location 100 may include a number of rooms corresponding to the number of rooms in the house. In an exemplary embodiment, the 360° virtual location 100 includes the doorways that are present in the physical location. In an exemplary embodiment, the user may be presented with a first viewpoint in a first room of the physical location. If the user wishes to change from the first viewpoint to a second viewpoint in a second room of the physical location, the VR memory bank is configured to move the user through the one or more doorways from the first room to the second room, as if the user was actually walking through the physical location.

In an exemplary embodiment, after the 360° virtual location 100 has been created based on the 360° photograph, the VR memory bank performs an analysis of the 360° virtual location 100. Specifically, the VR memory bank is configured to automatically detect planar regions within the location 100. For example, if the 360° virtual location 100 is a living room, the VR memory bank is configured to detect the planar surface associated with the screen of a television (TV), the front of a picture frame, and/or any other suitable planar surface on which a media asset may be presented to the user. In an exemplary embodiment, the VR memory bank is configured to perform object recognition on the 360° virtual location 100. For example, the VR memory bank is configured to automatically detect a radio, a record player, a gramophone, a compact disc (CD) player, an mp3 player, a stereo system, a speaker, a cassette player, and/or any other suitable object on which a media asset may be presented to the user. In an exemplary embodiment, if the VR memory bank fails to detect a planar region or object or incorrectly detects a non-planar region as planar, an administrator of the VR memory bank or a user with administrative access may manually adjust the 360° virtual location to ensure accuracy.

In an exemplary embodiment, the VR memory bank is configured to instantiate a video-texture surface anchored on each detected planar region within the 360° virtual location 100 as at least one visual media outlet. In another exemplary embodiment, the VR memory bank is configured to instantiate a positional-audio source anchored on each detected object (e.g., the radio, record player, etc.) within the 360° virtual location 100 as at least one audio media outlet. The VR memory bank is configured to register the video-texture surfaces and positional-audio sources within the 360° virtual location 100 so that the video-texture surfaces and positional-audio sources remain static if the viewpoint of the user changes.

In an exemplary embodiment, the room 100 further comprises one or more additional elements that may be made interactable. For example, if the room 100 is a kitchen of a house, the refrigerator may be made interactable. The user may interact with the refrigerator to open the door to reveal one or more food products placed therein. Subsequently, each of the one or more food products may also be interactable. If the user interacts with the one or more food products (which may correlate to the user's favorite or preferred foods), an order may be placed with the assisted living facility's kitchen, a grocery delivery service, a food delivery service, and/or any other suitable third-party food service. In an exemplary embodiment, the room 100 may be replicated with a poster or other memorabilia on the wall associated with the user's favorite sports team. For example, the memorabilia item may include a pre-defined uniform resource locator (URL) embedded therein to direct the user to the team's official website and/or merchandise store. In another exemplary embodiment, an object in the room 100, such as a blanket, may be interactable and include a pre-defined URL which links directly to an online retailer selling the item. The user would subsequently be able to purchase the item directly from the retailer. In an exemplary embodiment, if the user selects a food to be ordered from a food service or an object to be ordered from an online retailer, the VR memory bank may further require authorization from the administrator (such as an employee of the assisted living facility) or the user with administrative access (such as a family member of the senior citizen).

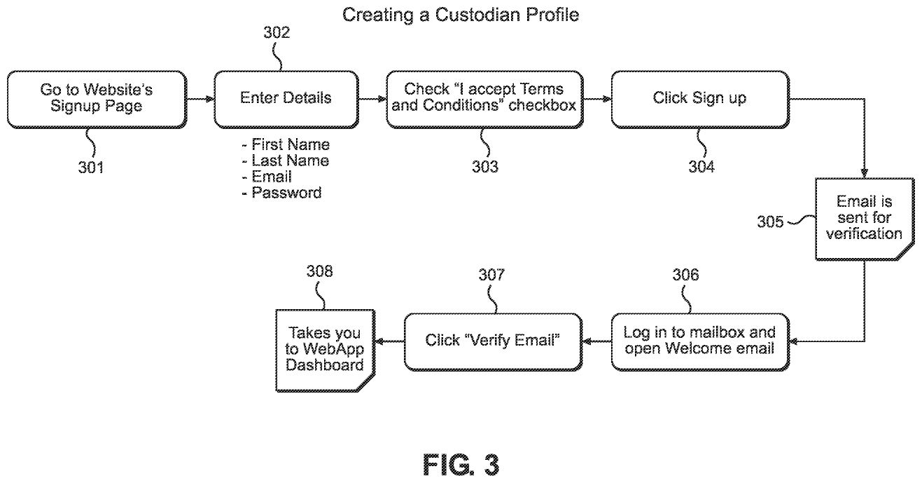

Referring now to FIG. 3, there is shown a flow chart for creating a profile for the VR memory bank. An initial user profile is created first, in order to allow the VR memory bank system to be individualized. In an exemplary embodiment, the VR memory bank is configured with a hierarchical user profile structure. For example, the administrator or a user with administrative access may have the most access permissions of a plurality of access permissions, one or more contributor profiles may have an intermediate number of access permissions of the plurality of access permissions, and one or more end user profiles may have the least access permissions of the plurality of access permissions. In this exemplary embodiment, the end user profile may be the senior citizen utilizing the VR device of the VR memory bank.

In an exemplary embodiment, the initial user profile may be referred to as the administrator or a custodian profile. In order to create the custodian profile, a user navigates to the proper page 301 to initiate account registration. During account registration, the user is elicited to enter personal details 302, such as first name, last name, email, and a password. In another exemplary embodiment, additional or different information may be elicited from the custodian. For example, the custodian may enter a phone number, a digital wallet ID, or a social media profile name. After entry of personal details 302 is complete, the custodian is elicited to agree to the terms and conditions 303 as well as to finalize the sign-up process 304.

In an exemplary embodiment, the contact information of the custodian is verified 305. Verification may be accomplished through an automatically generated email, through a text message, through a phone call, through an authentication app, and/or through any other suitable electronic verification means. For example, the custodian receives an automatically generated email 306, which includes a clickable link 307 to verify the custodian. Once verification is complete, the custodian is taken to a dashboard 308 in order to control and customize the 360° virtual location 100. The dashboard 308 is configured to facilitate the custodian to perform a variety of actions within the individualized VR memory bank (as detailed below).

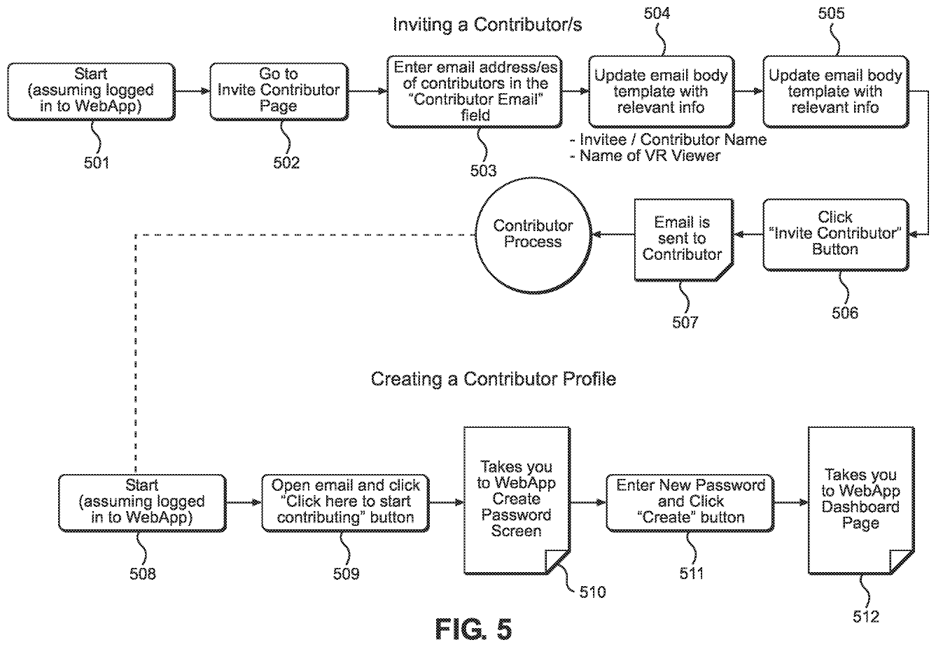

Referring now to FIG. 5, there is shown a flow chart for adding a user to the system for the VR memory bank. In an exemplary embodiment, the dashboard 308 is configured to facilitate the custodian to add or remove one or more additional users to the VR memory bank. For example, the custodian may add one or more additional custodians, one or more additional contributors, and/or one or more additional end users. In an exemplary embodiment, the custodian logs into 501 the dashboard 308 and navigates to the “Invite Contributor” page 502. The custodian is elicited to enter identifying information and contact information for the one or more additional users to be invited. For example, the information may include an email address, phone number, address, a digital wallet ID, social media profile name, and/or any other identifying information or contact information. The VR memory bank generates a message template 504 that is editable 505 by the custodian for personalization to the recipient. Once the message is personalized 505, the custodian presses a button to send the message 506, at which point the VR memory bank sends the invitation message 507 to the recipient. Once the one or more additional users have been invited, each additional user will need to create a profile and log in 508 (see FIG. 3 above). Each additional user accepts the invitation within the invitation message 507 by interacting with the clickable link 509. The additional user navigates the VR memory bank login page 510 and creates a password 511 before being directed to a dashboard 510.

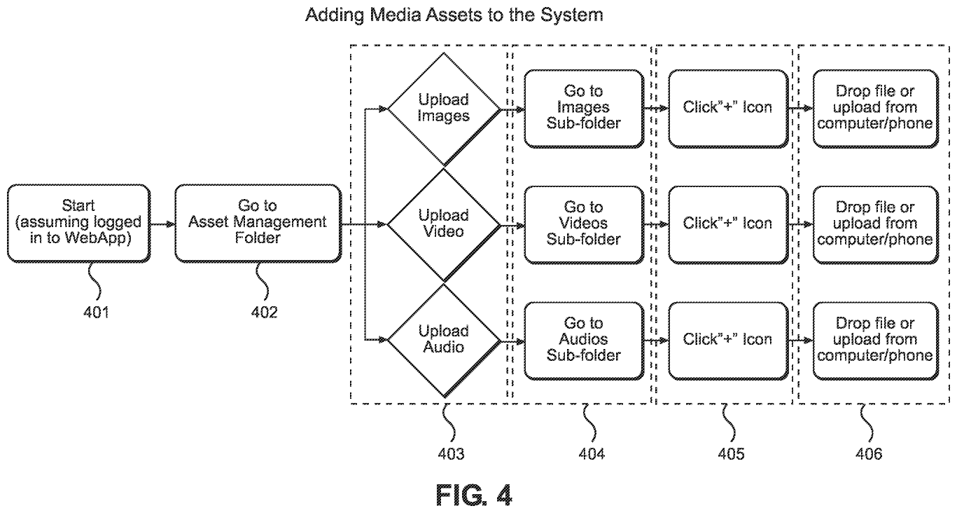

Referring now to FIG. 4, there is shown a flow chart for adding media assets to the system to be presented by the VR memory bank. In an exemplary embodiment, the custodian or one or more contributors logs into 401 the VR memory bank. Within the respective dashboard 308, 510; the custodian or one or more contributors navigates to the Asset Management folder 402. The media assets in the form of image files, video files, or audio files are uploaded 403 to the VR memory bank. In an exemplary embodiment, the custodian navigates to the sub-folder 404 associated with the media asset file type to be uploaded, interacts with a button such as a “+” icon 405, and selects the desired file to be uploaded 406. When the desired file is uploaded, the VR memory bank also stores the metadata associated with the desired file, such as time, locations, and/or any other metadata tags.

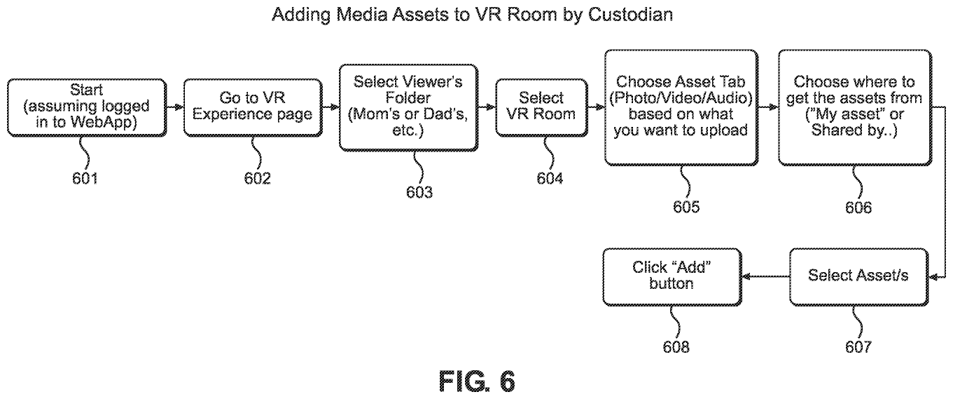

Referring now to FIG. 6, there is shown a flow chart for managing the virtual reality experience of the VR memory bank. In an exemplary embodiment, the custodian logs into 601 the VR memory bank. Within the dashboard 308, the custodian navigates to the VR Experience page 602. From within the VR experience page 602, the custodian selects a desired viewer's folder 603. The desired viewer is the end user for whom the custodian is curating media assets, such as a mother, father, and/or any other person for whom curation is needed. At least one desired viewer is associated with each 360° virtual location 100. In an exemplary embodiment, when the 360° virtual location 100 comprises at least two rooms, the custodian selects 604 which room in which to curate media assets. In an exemplary embodiment, the 360° virtual location 100 comprises a single room for curation. After selecting the room within the 360° virtual location 100, the custodian selects 605 which type of media asset to curate, whether image file, video file, and/or audio file type. The custodian is elicited to select 606 a media asset from the custodian's personal files or select at least one media asset that was uploaded 403 to the VR memory bank. After selecting 607 at least one media asset, the custodian interacts 608 with the VR memory bank to add the media asset to the 360° virtual location 100. In an exemplary embodiment, the custodian selects one of the video-texture surfaces or positional-audio sources anchored within the 360° virtual location 100. The selected at least one media asset is associated with the selected video-texture surfaces or positional-audio sources for presentation to the desired viewer within the 360° virtual location 100.

In an exemplary embodiment, the VR memory bank further comprises one or more media policies governed by a policy engine. The media policies are configured to assist the VR memory bank in determining which media assets are assigned to which video-texture surface/positional-audio source, which contributors are permitted to upload what types of content, during what times of the day media assets can be accessed, and/or any other suitable media policy. For example, when the 360° virtual location 100 comprises a positional-audio source automatically detected by object recognition, a media policy would prohibit the custodian from assigning a video file to the positional-audio source and would only allow audio files to be associated therewith. In another example, a media policy may prevent a contributor from uploading a particular type of media asset (e.g., image, video, audio) by default unless the custodian grants additional access permissions. In an exemplary embodiment, the VR memory bank comprises a media policy to review the content of an uploaded media asset. For example, the media policy would use an artificial intelligence (AI) algorithm to review the content of uploaded media assets for potentially harmful material (e.g., violent or adult-rated video content). If the AI algorithm detects potentially harmful material, the uploaded media asset is flagged for additional review by the custodian and is not presented to the end user until custodian review is completed.

In an exemplary embodiment, the user is capable of interacting with the at least one visual media outlet and/or the at least one audio media outlet to access the uploaded media assets approved by the custodian. In an exemplary embodiment, the VR memory bank comprises one or more action gates associated with the interactive elements of the VR memory bank. After the user selects a media asset to play and prior to the VR memory bank presenting the media asset, an action gate may check for additional input from the custodian to approve or deny the action taken by the user. In an exemplary embodiment, the VR memory bank comprises an action gate after a user selects an interactive element to order food from a food service or to buy an item from an online retailer. In an exemplary embodiment, the one or more action gates may be resolved automatically by the VR memory bank in accordance with the one or more policies of the policy engine, or the one or more action gates may require manual resolution by the custodian. The one or more action gates serve to reduce or prevent unnecessary and/or inadvertent purchases by the user, who may or may not be technologically literate.

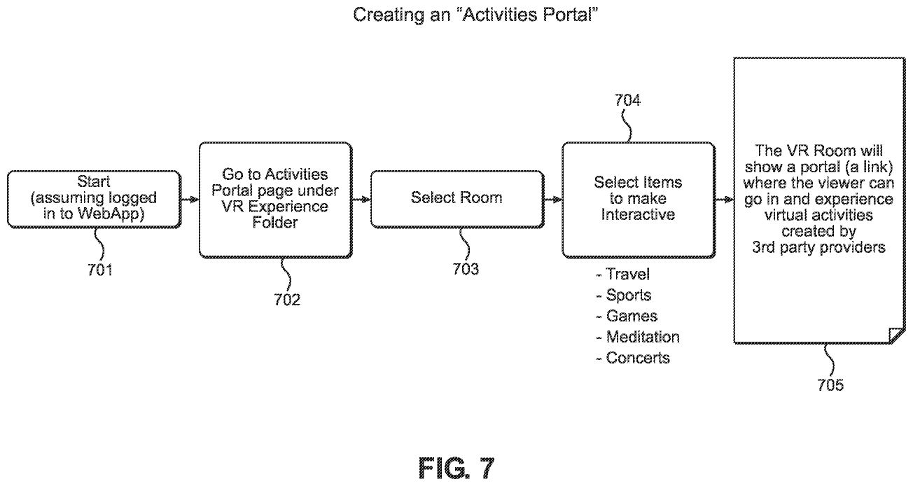

Referring now to FIG. 7, there is shown a flow chart for enhancing the virtual reality experience of the VR memory bank. In an exemplary embodiment, the custodian is empowered to create a more interactive experience for the desired viewer. In the shown embodiment, the custodian logs in 701. The custodian then navigates to the desired page to enhance the user experience 702. The custodian must then select a room 703 within the 360° virtual location 100. Once the room is selected, the custodian may then select items in a room to become interactive 704. The custodian may also select interests of the user and links for the selected items 704. In one embodiment these links may be created by third parties and direct a user to an advertisement or a shopping area 705.

In another embodiment the system automatically selects items and connects links to these items. In this embodiment the system may deploy AI image and text recognition in order to match items with appropriate links. In different embodiments links may be capable of a multitude of different interactions.

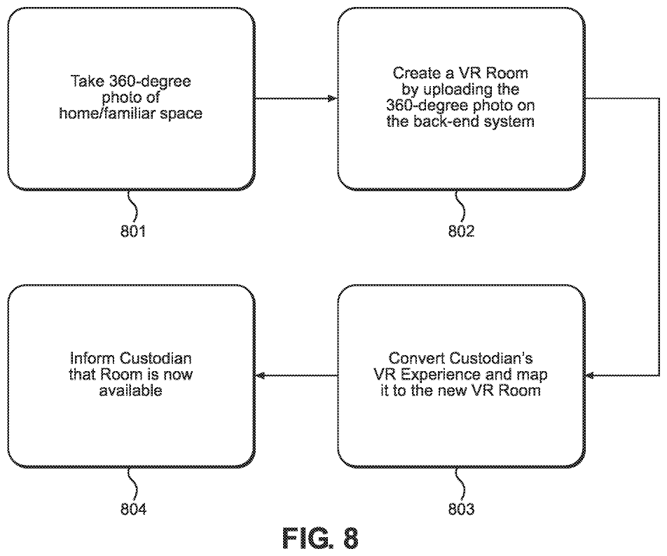

Referring now to FIG. 8, there is shown a flow chart of a method for creating a custom room and granting access to the same. The method starts by taking a 360° photograph of the home or room to be created 801. In some embodiments, multiple photographs will be needed. Next, the photo(s) must be uploaded to the webapp so that the room can be digitally created 802. After the room is digitally created, the proper individuals are given access the room 803. In one embodiment, the custodian of the room is notified that the room is created 804.

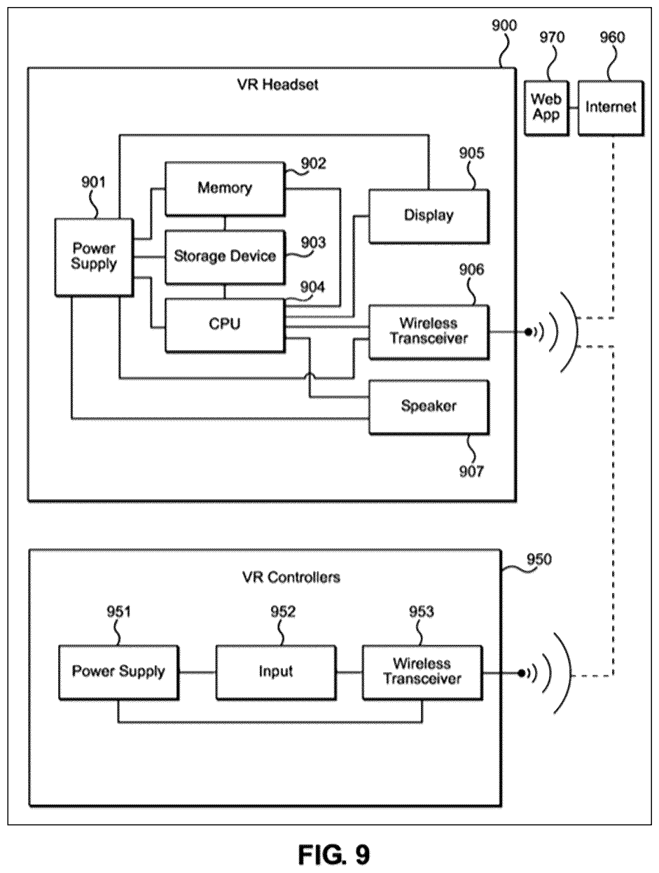

Referring now to FIG. 9, there is shown a wiring diagram of an embodiment of a virtual reality system. In one embodiment, the virtual reality system includes a VR headset 900 and at least one controller 950. In the shown embodiment, the virtual reality headset 900 includes a power supply 901. The power supply 901 ensures that no extra cords are needed. In one embodiment, the power supply 801 is a rechargeable battery. This allows for continued use of the power supply 901. The power supply 901 is operably coupled to each of the components of the virtual reality head set 900. In one embodiment, the components include a memory 902 which is operably coupled to a storage device 903. In one embodiment, the storage device 903 is a solid-state hard drive. The memory 902 and the storage device 903 are operably coupled to a CPU 904.

The CPU 904 is operably coupled to several additional devices. The CPU 904 is operably coupled to a display 905. The display 905 is configured to be over the eyes when placed in the virtual reality head set 900. The CPU is further coupled to a speaker 907. The speaker 907 allows for the virtual reality headset 900 to produce sound fully immersing the user in the experience. In some embodiments, the CPU 904 is operably coupled to a wireless transceiver 906. In one embodiment, the wireless transceiver 906 allows the virtual reality headset 900 to connect to the internet 960. In one embodiment, the internet connection 960 allows the virtual reality headset 900 to connect to the web app/web site 970. In another embodiment the wireless transceiver 906 allows the virtual reality headset 900 to connect to at least one controller 950.

In one embodiment, there is a single controller 950 which allows a user to control the virtual reality device. In another embodiment there is a plurality of controllers 950 which allow a user to control the virtual reality device. In different embodiments, the controllers 950 are handheld; in other embodiments, the controllers are made up of other components such as a treadmill. This availability of different controllers 950 allows for different immersive experiences.

In each embodiment, a controller 950 includes at least a power supply 951. In some embodiments the power supply 951 is internal. In other embodiments, the power supply 951 is external and not part of the controller 950, but supplies power in the same manner as an internal power supply 951. The power supply is connected to an input device 952. In some embodiments, the input device 952 is a button. In some embodiments, there is a plurality of input devices 952 included in each controller 950. In other embodiments, other input devices 952 may be used. In one embodiment, the input devices 952 are connected directly to a wireless transceiver 953. This transmits the inputs from the controller 950 to the CPU 904 of the virtual reality headset 900. In another embodiment, the controller 950 may include its own CPU to process the inputs before they are sent to the virtual reality headset 900.

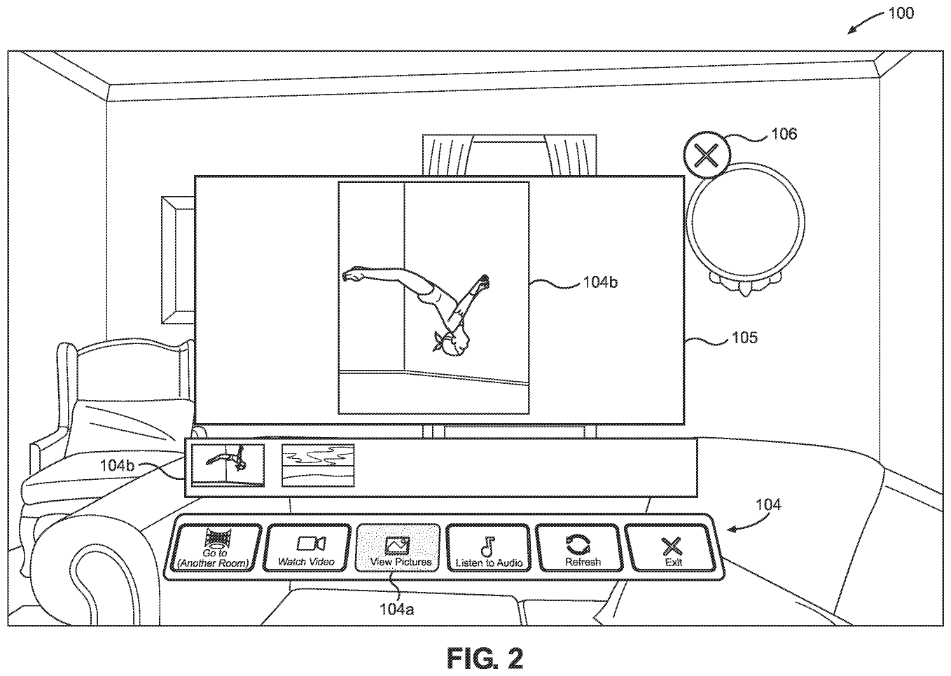

Referring now to FIG. 2, there is shown another room created for use on virtual reality device of the VR memory bank according to a second embodiment of the present invention. In this shown embodiment, the 360° virtual location 100 is a sitting room. In various embodiments, the 360° virtual location 100 may include items such as televisions, picture frames, or radios. However, in this embodiment, these items are not needed for viewing media assets.

In this embodiment, there is a menu bar 104 displayed on the screen. The menu bar has at least one selection button 104a thereon. In this embodiment, when a desired selection button 104a is pressed, the associated media asset 104b is displayed in a small display. From there, the media asset 104b may be selected for display on a larger pop-up screen 105. In one embodiment, when the user no longer wishes to view or listen to the selected media asset 104b, the pop-up screen 105 can be closed using the exit button 106.

In one embodiment, the user can use the electronic device in order to move to another room within a 360° virtual location 100. In another embodiment, the user can walk to an entirely new 360° virtual location 100. In this embodiment, the user can enter a new 360° virtual location 100, but using the menu buttons 104a in order to select a new location to visit.

Those skilled in the art will recognize improvements and modifications to the preferred embodiments of the present disclosure. All such improvements and modifications are considered within the scope of the concepts disclosed herein and the claims that follow.

What is claimed is:

1. A method of operating a virtual reality (VR) memory bank, the method comprising:
creating a 360° virtual location to be displayed on a virtual reality headset, wherein the 360° virtual location is a replication of a physical location created from a 360° photograph;
automatically detecting one or more planar regions, within the 360° virtual location, associated with a visual media device within the physical location;
instantiating and anchoring a corresponding video-texture surface to each planar region of the one or more planar regions;
automatically detecting one or more objects, within the 360° virtual location, associated with an audio media device within the physical location;
instantiating and anchoring a corresponding positional-audio source to each object of the one or more objects;
including media assets within the 360° virtual location, wherein the media assets comprise at least one visual media asset and/or at least one audio media asset;
when the media assets comprise at least one visual media asset, displaying, at the selection of an end user, the at least one visual media asset on at least one video-texture surface; and
when the media assets comprise at least one audio media asset, playing, at the selection of the end user, the at least one audio media asset on at least one positional-audio source.

2. The method of claim 1, wherein the visual media device comprises a television or a picture frame.

3. The method of claim 1, wherein the audio media device comprises a radio, a record player, a gramophone, a compact disc (CD) player, a cassette player, a stereo system, a speaker, or an mp3 player.

4. The method of claim 1, wherein the 360° photograph is captured by a 360° camera.

5. The method of claim 1, further comprising:
selecting one or more additional elements within the 360° virtual location.

6. The method of claim 5, further comprising:
assigning an interactive action to each additional element of the one or more additional elements.

7. The method of claim 6, wherein at least one additional element of the one or more additional elements comprises a food item and the interactive action comprises ordering the food item.

8. The method of claim 6, wherein the interactive action comprises directing the user to an online retailer.

9. The method of claim 1, wherein:
the 360° virtual location comprises at least two rooms, and
each room of the at least two rooms is connected to at least one other room of the at least two rooms by an entryway.

10. The method of claim 9, wherein the VR memory bank is configured to facilitate the user walking from one room of the at least two rooms to another room of the at least two rooms through the entryway within the 360° virtual location.

11. The method of claim 1, wherein:
access to the 360° virtual location is restricted, and
the VR memory bank further comprises a custodian, the custodian grants access to one or more additional users as a contributor or an end user.

12. The method of claim 11, wherein the VR memory bank allows the custodian and the one or more additional users granted access as a contributor to add media assets.

13. The method of claim 12, wherein the added media assets are configured to be selectively displayed by the video-texture surface and/or to be selectively played by the positional-audio source.

14. The method of claim 11, further comprising:
selecting one or more additional elements within the 360° virtual location; and
assigning an interactive action to each additional element of the one or more additional elements,
wherein:
the interactive action comprises a request to a third-party service external to the VR memory bank, and
the custodian approves or denies the request.

15. The method of claim 1, further comprising at least one media policy stored on a policy engine.

16. The method of claim 15, wherein the at least one media policy prevents an audio media asset from being displayed on a video-texture surface and prevents a visual media asset from being played on the positional-audio source.

17. The method of claim 15, wherein the at least one media policy prevents media assets from being displayed or played outside of predetermined time windows.
